(19) United States
(12) Patent Application Publication
(10) Pub. No.: US 2023/0083443 A1
(43) Pub. Date: Mar. 16, 2023

(54) Detecting anomalies in physical access event streams by computing probability density functions and cumulative probability density functions for current and future events using plurality of small scale machine learning models and historical context of events obtained from stored event stream history via transformations of the history into a time series of event counts or via augmenting the event stream records with delay/lag information

(71) Applicants: Evgeny Saveliev, Bethesda, MD (US); Daniel Greene, Bethesda, MD (US); Catherine Baird, Bethesda, MD (US); Manuel Francisco Perez Gonzalez, Chevy Chase, MD (US); Dhamanjit Sehdev, Bethesda, MD (US)

(72) Inventors: Evgeny Saveliev, Bethesda, MD (US); Daniel Greene, Bethesda, MD (US); Catherine Baird, Bethesda, MD (US); Manuel Francisco Perez Gonzalez, Chevy Chase, MD (US); Dhamanjit Sehdev, Bethesda, MD (US)

(21) Appl. No.: 17/477,291

(22) Filed: Sep. 16, 2021

(51) Int. Cl. G06F 21/55; G06N 5/02; G06N 5/04

(52) U.S. Cl. CPC G06F 21/55; G06N 5/022; G06N 5/04; G06F 2221/034

(57) ABSTRACT

An anomaly score is computed for current and past physical access events using machine learning models. A transformation of the security events history into a time series of event counts, or augmenting the events history with the delay/lag information is used as an input to machine learning models. Machine learning models are used to estimate (compute) probability density functions for the currently observed parameters of security events. Cumulative probability density functions are computed from the probability density functions to be used to compute the anomaly score for the security events. The described method utilizes a collection of machine learning models to improve efficiency, accuracy and computation speed, by training the models on only a small subset of the accumulated history of security events to achieve higher performance of anomaly detection by narrow specialization of the models. When the anomaly score is beyond a threshold, injecting an anomaly alert network packet.

### CROSS-REFERENCE TO RELATED APPLICATIONS

Not Applicable

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### Technical Field

The present invention relates physical access control systems such as electronic door openers.

### Description of the Related Art

The present disclosure relates generally to anomaly detection on time-series data and more particularly to detection of anomalies in physical access control systems particularly at entry and exit portals for various event types, actors, locations, times, and day of work periods.

Generally, time-series data can be considered as a sequence of data points or records (e.g., arrays of numbers), measuring one or more variables over time, and stored or indexed in time order. The records may include timestamp information.

Anomaly detection on time-series data is a topic that has attracted considerable attention in the data mining community, and its many application areas. A number of studies have been conducted in recent years, with varying approaches including parametric modeling, pattern mining, clustering, change point detection, classification and others. Most research works to date, however, have focused on the question of accuracy in detecting outliers and change points present in time-series data. What is known about probability and machine learning is well disclosed by the following:

1) Density Estimation for Statistics and Data Analysis, by B. W. Silverman, 1998, Chapman & Hall/CRC, ISBN-13: 978-0412246203 ISBN-10: 0412246201. This book can be used as a reference for detailed disclosure of the concepts of Probability Distribution Functions and Cumulative Distribution Functions.
2) Bayesian Reasoning and Machine Learning 1-st edition, by David Barber, 2012, Cambridge University Press ISBN-13: 978-0521518147, ISBN-10: 0521518148. This book can be used as a reference for detailed disclosure of possible machine learning architectures (mixture models etc.).

### 3) Deep Learning, by Ian Goodfellow et. al, 2016, MIT Press, ISBN-13: 978-0262035613 ISBN-10: 0262035618.

This book can be used as a reference where training is disclosed, especially in the categorical cross-entropy loss and stochastic gradient descent method.

As is known, general machine learning systems do not scale well with the increase in the amount and variance in the data. Both databases and training software become uneconomically large as the systems grow. And the performance of applying machine learning to a real time system often becomes unsatisfactory for its intended purpose and is thus bypassed. For many substantial sized enterprises having a large number of customers and employees (such as those exceeding 500 unique “actors”) with wide ranges of responsibilities distributed across many physical and logical locations, access control could be improved, if machine learning could be applied in a more efficient manner.

Heretofore, no known system or methods have addressed the question of efficiency in a suitably focused anomaly detection system to build and perform access control models without ensuing bottlenecks in data acquisition and analysis. What is needed is a way to reduce friction in physical access control rather than adding delay for authentication. The present invention introduces a method of increasing efficiency of machine learning models applied to anomaly detection by distributing the workload to a plurality of models, each trained/designed to be applied to only a small subset of records in the event stream. The plurality of models may be instantiated into a multi-core processor as small virtual machines as selected and run in parallel.

As is known, a machine learning model is a mathematical function expressed as a computer executable code. It can be a single evaluation of a simple mathematical function, or it can be a complex multi-step process of evaluating mathematical expressions. The main feature of machine learning models is that the configuration of the mathematical function (parameters, coefficients, mathematical operations involved) is partially created by an algorithm (so-called training algorithm), therefore it is code written by a machine, rather than a human. Thus, training a machine is patentable subject matter as an invention.

Training of machine learning models is a process of achieving optimal configuration and adjusting coefficients of the mathematical expressions by using a well-defined algorithm to minimize an a priori defined loss metric or an objective function. Machine learning models can be stored in a computer readable memory by writing into memory a description of the configuration of the mathematical function and the values of all coefficients involved in the expression. Machine learning models can be loaded (or converted into executable code) by openly available computer code libraries that can read the stored configurations and stored coefficients' values and recreate the executable code. Training is iterated toward achieving a loss metric whereupon the model is promoted into a repository.

A time series is a sequence of computer records of values for sets of parameters augmented with a timestamp information. For the purposes of this document, an event stream is a time series of events for which records may arrive at random time intervals. Implicitly, an event in the event stream carries information that one event has occurred. This distinction between time series and event streams is only semantic, and the terms will be used interchangeably in this document, when such use would not create ambiguities.

Windowing is a process of aggregating time series stored records using predefined intervals of time. For example, computing event counts for each hour, thus transforming an event stream of events that arrive at random times into a time series that is updated hourly. This process creates an entirely new time series with a different (often significantly smaller) number of records which store a different set of parameters.

Lag/delay information is the measure of units of time passed between two subsequent events in an event time series. An often used technique to augment event streams (event time series) with lag/delay information, thus creating a new time series, which in addition to previously recorded values now carries an additional value of lag/delay. This process overloads an already existing time series.

Probability Density Function or PbDF (alternative name probability mass function) in this context is a mathematical function defined on a finite domain of either an ordered set of numbers or ordered set of subintervals of real numbers. The values of the probability density function are stored in the computer memory as an array of values.

Cumulative probability density function or CDF is a mathematical function that is obtained by performing a cumulative sum procedure of a given PbDF. CDF will share the same domain as PbDF and can be stored in the computer memory as an array of values. Evaluation of PbDF and CDF at a given input value is a simple lookup procedure, where the value of the function is retrieved from the array stored in the computer memory for the position in the array that corresponds to the input value.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

According to one or more embodiments of the present invention, a process receives current and past physical access events and computes an anomaly probability score for the current physical access event.

The current event and the past history are transformed by either converting the events records into a time series of event counts by time intervals (common term in the industry is “windowing”), or by augmenting events with the time delay/lag information. The transformed events are then used as an input to a machine learning model, which computes the probability density function (PbDF) for the current or future sample in the time series. The computed PbDF is then used to compute cumulative probability distribution function (CDF), which contains the anomaly score for the current event.

The machine learning model is selected from a plurality of models to match a subset of parameters/values recorded in the physical access events. Each model is trained to compute PbDF distributions only for a small subset of the values. This is done to balance efficiency, accuracy, and the speed of analysis. One or more embodiments of the present invention may be implemented with machine learning models architectures such as neural networks, Bayesian estimators, mixture models.

The anomaly score is determined by evaluating the computed CDF at the value present in the current record in the transformed time series.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s) such as an accumulator, (ii) software module(s) stored in a computer readable storage medium (or multiple such media) and implemented on a hardware processor, or (iii) a combination of (i) and (ii); any of (i)-(iii) implement the specific techniques set forth herein. Programmable logic circuits are synthesizable for equivalent embodiment.

Techniques of the present invention can provide substantial beneficial technical effects. For example, one or more embodiments may provide for:

micro modeling of subsets of event data to fractionalize probability calculations for variable time intervals or event types or individual actors or groups, reducing the anomaly detection problem for high dimensional time-series data where event counts and inter-event lag time can be readily programmed, is computationally efficient, and has a strong parallelization potential; and

achieving high predictive capacity of the computed probability density function distributions due to the use of the historic security events as a context in which the current security event is evaluated.

These and other features and advantages of the present invention will become apparent from the following detailed description of illustrative embodiments thereof, which is to be read in connection with the accompanying drawings.

### BRIEF DESCRIPTION OF THE SEVERAL VIEWS OF THE DRAWINGS

The foregoing and other objects, aspects, features, and advantages of the disclosure will become more apparent and better understood by referring to the following description taken in conjunction with the accompanying drawings, in which reference will be made to embodiments of the invention, example of which may be illustrated in the accompanying figure(s). These figure(s) are intended to be illustrative, not limiting. Although the invention is generally described in the context of these embodiments, it should be understood that it is not intended to limit the scope of the invention to these particular embodiments. Preferred embodiments of the present invention will be described below in more detail, with reference to the accompanying drawings:

FIG. 1 is a block diagram depicting an exemplary computer system embodying a method for computing anomaly score for a physical access security event, according to an exemplary embodiment of the present invention.

FIGS. 2A, 2B, 2C and 2CD depicts the conceptual transformation of a security event and accompanying history of security events into an anomaly score using the transformation of the events stream into a time series of event counts or using event stream augmented with the time delay function.

FIG. 3 is a block diagram of apparatuses in a non-limiting exemplary physical access control system.

FIG. 4 is flowchart of method steps performed in a server as an embodiment of the claimed invention.

FIGS. 5A, 5B, 5C, and 5D are conceptual visualizations of the transformations of event data to models, which compute the probability density functions.

FIG. 6 A and FIG. 6 B is a conceptual visualizations of probability density functions defined on a finite domain of possible values that can be measured for the current event count or current event lag/delay and the subsequent transformations of PbDFs to CDFs. FIG. 6A is a conceptual visualizations of probability density functions defined on a finite domain of possible values that can be measured for the current event count and the subsequent transformations of PbDFs to CDFs. FIG. 6B is a conceptual visualizations of probability density functions defined on a finite domain of possible values that can be measured for the current event lag/delay and the subsequent transformations of PbDFs to CDFs.

### DETAILED DESCRIPTION

### Security Event Stream and Security Event Records

Within this patent application we define a security event stream as a time series of security events consisting of individual records of events and actions occurred in the physical access control infrastructure. The records in the stream are sent and received in near real time from access portals to the central servers infrastructure for storage and analysis. The records are created and sent at random time intervals and at times exceed rates of thousands of records received per second. To aid security personnel in their task of monitoring the access to the secured areas, an anomaly score may serve as an indication of an event that deserves higher scrutiny than others.

A record in the security event stream, or simply a security event is an array or a collection of values or identifiers concerning information about
1. A timestamp of the occurred event,
   a possible embodiment of this field may be a Unix timestamp or a string written as a UTC timestamp.
2. An event type identifier, which include, but not limited to:
   a. Access granted event type
   b. Access denied event type
   c. Unauthorized access event type
   d. Internal service or maintenance event type
      A possible embodiment of an event type identifier can be an integer value enumerating all possible event types.
3. An actor identifier, which identifies the person or an entity that is granted or denied access, or otherwise is an initiator of the event.
   A possible embodiment of an actor identifier can be a globally unique identifier (GUID) or a unique integer value.
4. A Device identifier, which identifies the device that is reporting the interaction, such as a credential reader at a door, or a camera.
   A possible embodiment of a device identifier can be a globally unique identifier (GUID) or a unique integer value.
5. A location identifier or identifiers, this may identify the location of a particular access control device, or identify the group of such devices. It may correspond to a physical group subdivision, such as a building or a floor, or may identify a logical subdivision, such as a group of locks that lead to the space occupied by a particular department.
   A possible embodiment of a location identifier can be a globally unique identifier (GUID) or a unique integer value.

### Computing Anomaly Score

According to one or more embodiments of the present invention, a server receives a current security event for analysis in concert with stored security events; extracts the identifiers for the actor, the door and site and chooses a subset of the identifiers for analysis (all of them, a pair, or a single one). The server obtains from non-transitory media a history of security events of length N for the chosen combination of actor/door/site. The data in this history is transformed into a data structure for inputting into a machine learning model as a time series of event counts and augments each event dataset with delay information from its corresponding previous event. The process includes selecting, from a plurality of models, a model that is trained for computing probability density function for the chosen subset of security event identifiers; computing the probability density function (PbDF) by the selected predictive model using the data structure; computing the cumulative distribution function (CDF) from the PbDF; computing an anomaly score for the current event using the CDF. and in an embodiment, inserting an anomaly alert packet into the event stream. In an embodiment, N covers a pay period.

A security event is a record in the security event time series about any event, interaction with, or action taken that happens within the physical access infrastructure. This includes but is not limited to
Individuals gaining access to secured areas by presenting valid credentials to a sensor or a reader. In this case the security event will carry information about the actor (credential holder), door, location, and timestamp. The type of security event will identify that access to the area was granted.
Access to secured areas not being granted due to invalid credentials presented. This security event may carry information about actor (if credential belongs to a known individual), door, location, timestamp, and (when available) information about the credential used. The type of this security event will identify that access was denied
Individuals logging into the administrator web portal.
Motion or intrusion being detected by a camera.
Devices sending diagnostic information.

Splitting the task of computing the probability density function among a multitude of machine learning models using models that match all or a subset of parameters recorded in the security event allows for reduction of storage size, computational complexity and speed of evaluation, as well as allowing to compute anomaly score in multiple categories.
Using models that match only the actor identifier allows for detecting anomalous activity when the time of the event is unusual for the actor. Such models will allow for detecting anomalies when an actor gains or grants access to an unusual combination of doors, such as the same credentials used to get access to areas that are physically too far apart for the observed time difference between events.
Using models that match only the door/device identifier allows for detecting anomalous activity when the time of the event is unusual for the door/device. For example, there is a secured area that should only be accessed during certain hours, while in general activity on the site may be happening at other times.
Using models that match the actor, door and location identifiers will allow for detecting anomalies when the usage patterns for an individual change significantly.

Credential and identity indicia are associated with each actor. The indicia may be biologic such as fingerprints or retina, or electronic, or magnetic, or secret words or numbers or optical images. The portals are associated with sensors for receiving said indicia and augmenting them with the date time information and identifying information about the device and location.

Determination of probability density functions is done by applying a machine learning model to transformed security events comprising
1. Retrieving transformed security events from the non-transitory media;
2. Retrieving selected machine learning model configuration from the model repository;
3. Converting the machine learning model configuration into computer executable code using openly available computer code libraries.
   Examples of such libraries are Tensorflow, PyTorch, Theano, ScikitLearn;
4. Invoking the executable code using the transformed security events as an input;
5. Recording the array of numbers output by the machine learning model as values of the probability density function.

Computation of the anomaly score is performed by recording the observed value for the current security event (be it the event count or the delay) and performing a lookup procedure for the corresponding value from the CDF function array. A value close to zero would indicate a low anomaly score. A value close to 1 would indicate a high anomaly score.

As each credential bearer requests physical access to a secure space, a record is generated at the portal and sent over the network to be added to event history and analyzed by the anomaly score calculator. Transforming the time-series of events provides a probability for the observed parameters of the analyzed event.

The method of operation of the physical access control system includes
1. At the portal, receiving access requests via sensors or input devices, when a credential is presented to it.
   Recording the date and time of the request.
   Recording the identifiers of the actor (credential holder), device used to gain access (door) and the location of the request.
   Formatting a record with the above specified values and sending the record over the network for storage and analysis
2. At the server, receiving security events records
   Forwarding the records to the security event storage
   Forwarding the records to the anomaly score calculator
   Retrieving a history of security events matching the indicia chosen for analysis and forwarding it to the anomaly score calculator
   Retrieving machine learning models from the machine learning repository and forwarding it to the anomaly score calculator
   Orchestrating periodic training of machine learning models

The training algorithm assembles examples of observed security events to create a training dataset which includes examples of transformed security events history and observations of the time series parameter that pertains. The observed value is assumed to occur with probability 1. The machine learning model is optimized to produce values for the PbDF function that minimize the loss computed for the plurality of the examples assembled from the past events history.

The loss function employed in the training process is categorical cross-entropy. The computer codes for computing the value of the loss function are included as standard in many machine learning libraries, such as Tensorflow, PyTorch and others. Categorical cross-entropy loss, is understood by those skilled in the art to assign low values for computed PDFs that align with observed distributions of target values in training data (as known to practitioners of the art and reference in Section 3.13 of “Deep Learning”; Goodfellow 2016).

The procedure that minimizes the loss function by adjusting the configuration and parameters of the machine learning models is stochastic gradient descent. As discussed by Goodfellow 2016 section 5.9, where the optimization procedure is the stochastic gradient descent procedure which utilizes deterministic gradient descent procedure multiple times with random initializations. The computer codes for performing the optimization procedure are included as standard in many machine learning libraries.

Machine learning models trainer reads the events history and composes a list of all possible combinations of actor, door, location identifiers seen in the event history stretching over a predetermined time interval. For each possible combination of identifiers a corresponding machine learning model is created, trained, and submitted to repository together with the set of identifiers the model corresponds to.

At the creation stage, the machine learning model is initialized with random values of its coefficients. At the training stage, the configuration and the parameters (coefficients) are adjusted to achieve the minimum of the loss function. The loss function is computed by evaluation of the machine learning model for the entries in the training dataset.

The trained models are then transmitted to the non-transient storage media referred to as machine learning models repository.

Machine learning model trainer performs training procedure at regular intervals to maintain high predictive capacity of machine learning models in the dynamic and ever changing environment of access patterns of all actors functioning within the boundaries of the physical access control infrastructure.

The machine learning models, which compute PbDF function for security events transformed into event counts time series is done by performing the loss function optimization on the training dataset. The training dataset is assembled by selecting a number of consecutive security events, transforming the events into a time series of event counts; using the last value of the event count as an example of an observed value and the event counts preceding it as the input value for the machine learning model that is undergoing the training process. In other words, the process of assembling a training dataset is exactly the same as the process of preparing the input for machine learning models for computing anomaly scores for current events, except that the event to be analyzed is pulled from the storage media of the past events history rather than received over the network.

The machine learning models, which compute PbDF function for security events augmented with lag/delay information is done by performing the loss function optimization on the training dataset. The training dataset is assembled by selecting a number of consecutive security events, augmenting the events with the delay/lag information; using the last value of the lag as an example of an observed value and the events with lags preceding it as the input value for the machine learning model that is undergoing the training process.

During training the machine learning model is configured to output a probability density function that best reflects the expected behavior of actors and access patterns at doors and sites.

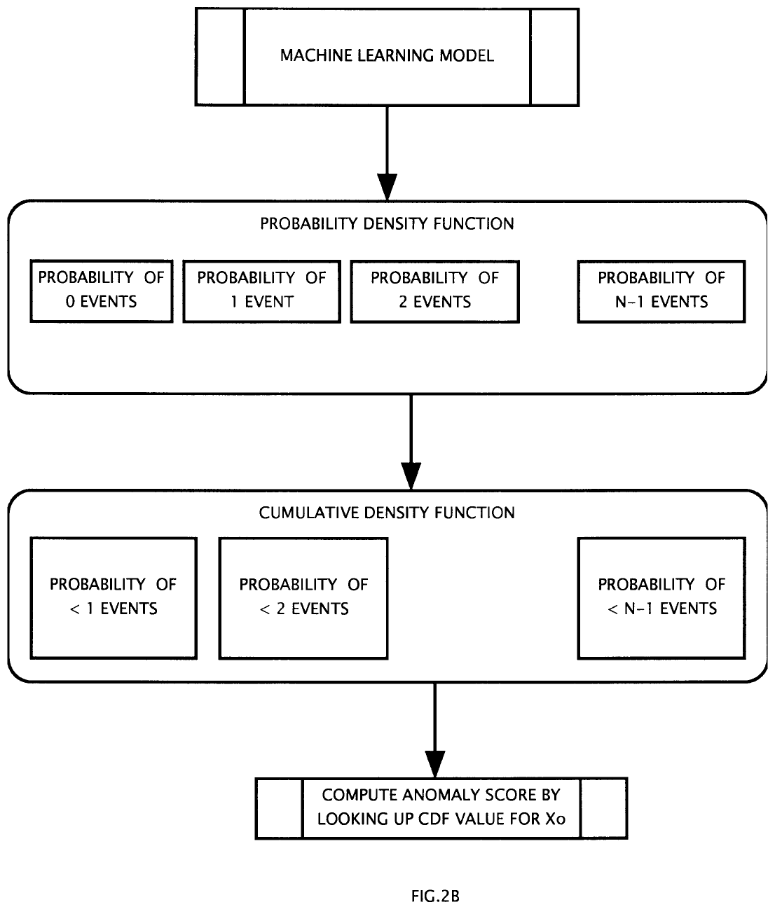

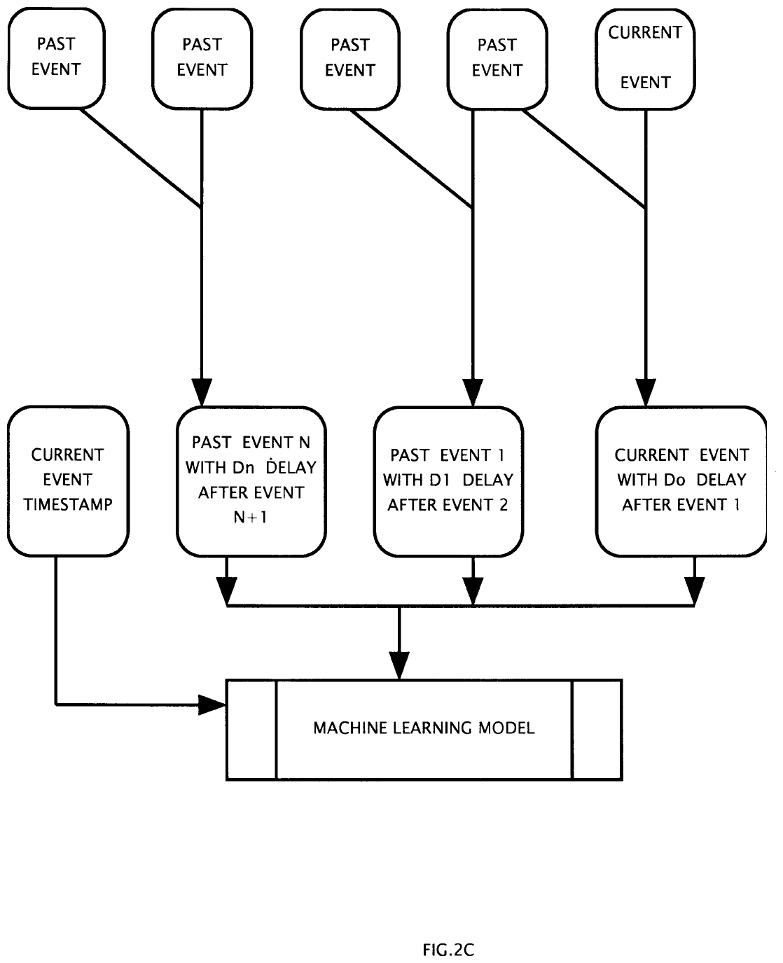

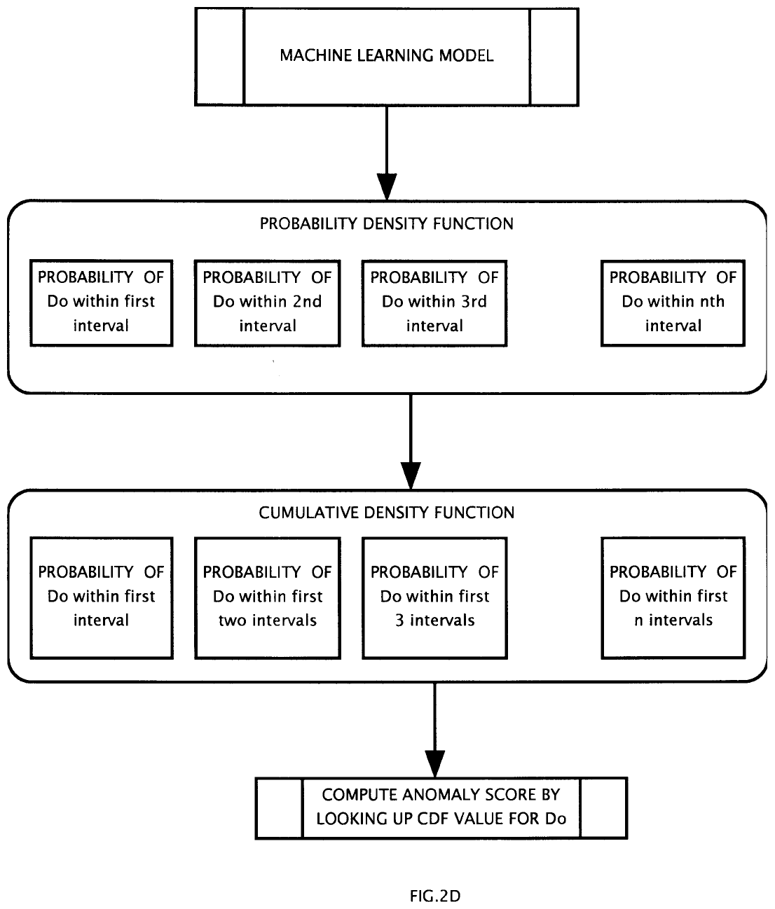

Referring now to FIGS. 2A, 2B, 2C, and 2D which illustrate conceptually, the inventive transformations of event data into anomaly scores: In FIG. 2A events are reported to a server from a terminal or a physical access control panel or a portal e.g. a door with a sensor and an actuator. Each security event may carry the information about an actor at a time at a location and have an event-type. The reception of a current event activates a transformation process to retrieve a plurality of past events and count the number of events within a plurality of intervals into a time series of event counts per interval which is provided to a machine learning model. In FIG. 2B the machine learning model performs a transformation of the event count time series into a Probability Density Function which is represented as an array of probability values for 0, 1, 2, 3, 4, . . . N−1 events per interval. A further transformation determines a Cumulative Density Function represented as an array of probability values for less than 1, less than 2, . . . less than N−1 events per interval.

An anomaly score is computed by evaluating the cumulative probability density function at the count of events in the current interval. In FIG. 2C, events are reported to a server from a terminal or a physical access control panel or a portal e.g. a door with a sensor and an actuator augmented with lag/delay information. Each security event may carry the information about an actor at a time at a location and have an event-type. The reception of a current event activates a transformation process to retrieve a plurality of past events with delay after the event which are provided to a machine learning model. In FIG. 2D the machine learning model performs a transformation of the event with delay time series into a Probability Density Function which is represented as an array of probability values for 0, 1, 2, 3, 4, . . . d delay per interval. A further transformation determines a Cumulative Density Function represented as an array of probability values for current delay within 1, 2, 3, or n intervals. An anomaly score is computed by evaluating the cumulative probability density function at the delay in the current interval.

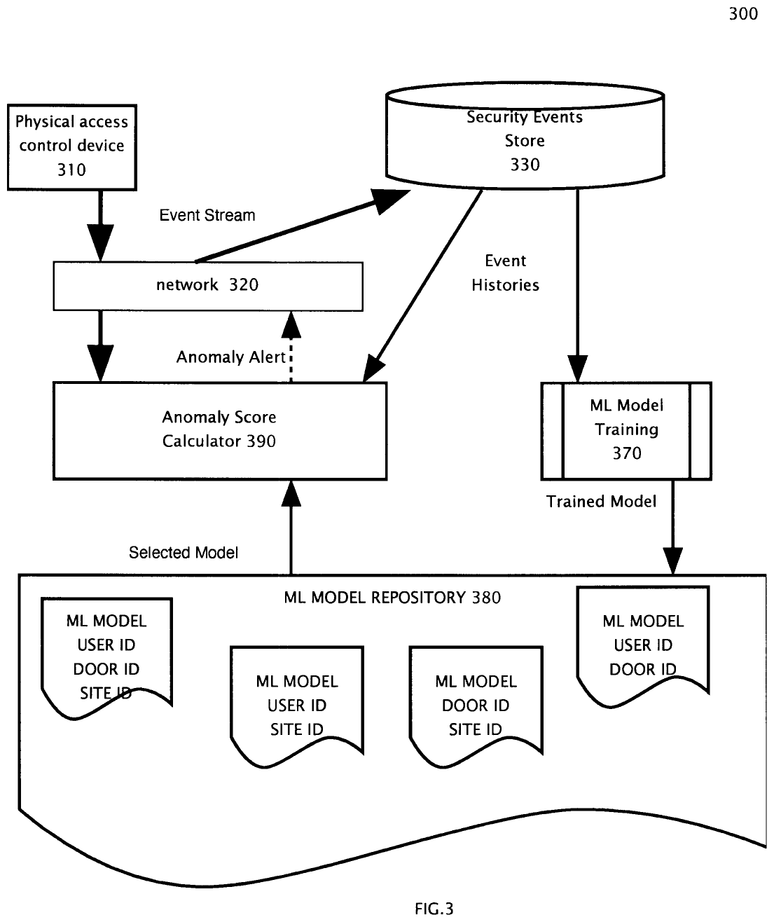

Referring now to FIG. 3 which illustrates a physical access control system 300. FIG. 3 illustrates a possible embodiment of the interconnected computer system consisting of a computer network 320 connecting one or more of physical access control devices, storage media for the security events, storage media for the trained machine learning models, anomaly score calculator, and machine learning model trainer. A Physical access control device 310 captures a Stream of Security Events and transmits Event Stream packets of datasets through a Network 320 to the Security Events Storage 330 and to the Anomaly Score Calculator 390. The Security Events Store 330 provides Security Events History to the Anomaly Score Calculator 390 and to the ML Model Training process 370. The resulting Trained Models are stored into ML Model Repository 380 keyed to various Users, for various Sites, and for various Doors. The Anomaly Score Calculator 390 receives each security event in the stream, through the network 320, along with similar security Events History from Security Events Storage 330, as well as a selected Model which is selected for matching the user, the site, the door, or other identifying indicia of Events. In an embodiment, the Anomaly Score Calculator 390 forms and injects an Anomaly Alert packet into the Event Stream on the network 320 when a calculated score exceeds a threshold such as a user set standard deviation multiple for example. The packet may include such event indicia as the user, the door, the site, the actor, the event type, the date-time or selected model.

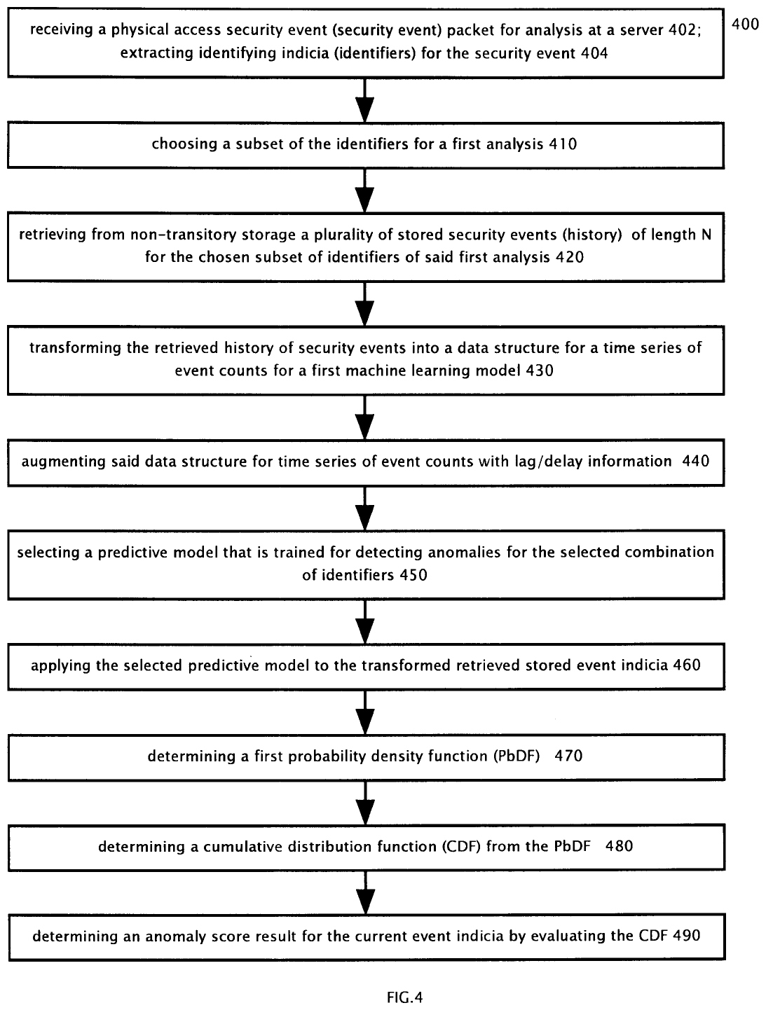

Referring now to FIG. 4 which illustrates a method performed at a server for computing the anomaly score for a physical access security event, the method 400 includes:

receiving a physical access security event (security event) packet for analysis at a server 402;

extracting identifying indicia (identifiers) for the security event 404;

choosing a subset of the identifiers for a first analysis 410;

retrieving from non-transitory storage a plurality of stored security events (history) of length N for the chosen subset of identifiers of said first analysis 420;

transforming the retrieved history of security events into a data structure for a time series of event counts for a first machine learning model 430;

augmenting said data structure for time series of event counts with lag/delay information 440;

selecting a predictive model that is trained for detecting anomalies for the selected combination of identifiers 450;

applying the selected predictive model to the transformed retrieved stored event indicia 460;

determining a first probability density function (PbDF) 470;

determining a cumulative distribution function (CDF) from the PbDF 480; and

determining an anomaly score result for the current event indicia by evaluating the CDF 490. In an embodiment, an anomaly packet is inserted in the event stream containing identity indicia and score when a score exceeds a threshold.

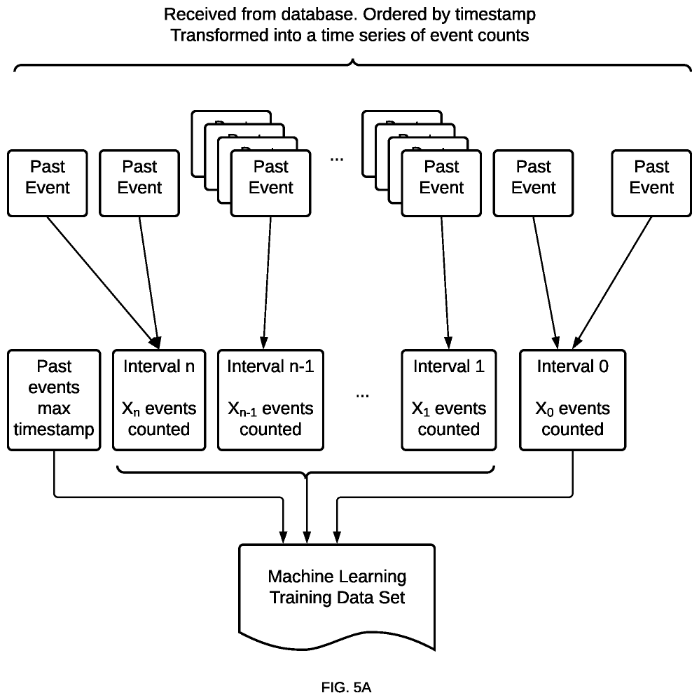

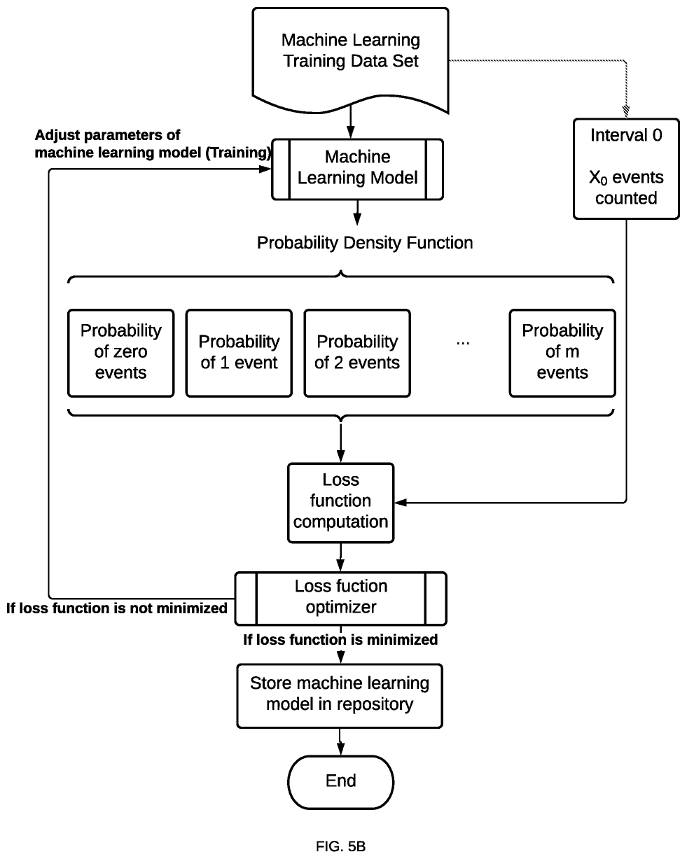

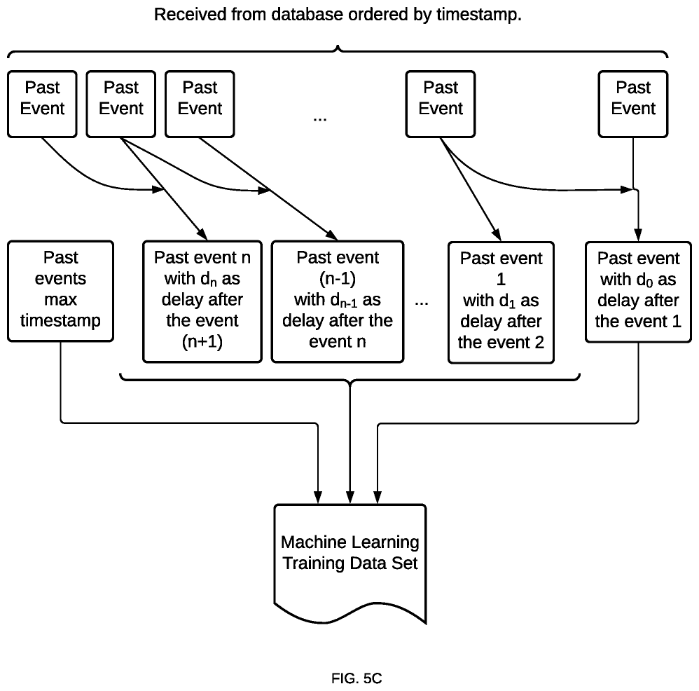

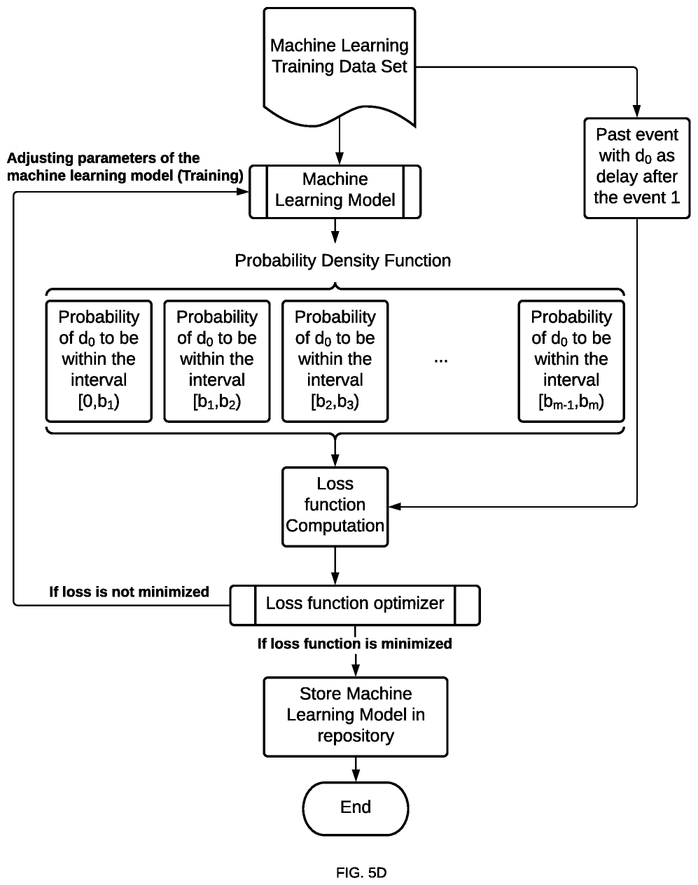

FIGS. 5A, 5B, 5C, and 5D illustrate a method of creating and training of machine learning models, which are used to generate probability density functions.

As illustrated in FIG. 5A, the machine learning models, which compute PDF function for security events transformed into event counts time series are derived from the counts of past events. The history is transformed into a time series which counts the events in each of n intervals. The training dataset is assembled by selecting a number of consecutive security events, transforming the events into a time series of event counts; using the last value of the event count as an example of an observed value and the event counts preceding it as the input value for the machine learning model. In FIG. 5B, The machine learning model is undergoing the training process. In other words, the process of assembling a training dataset is exactly the same as the process of preparing the input for machine learning models for computing anomaly scores for current events, except that the event to be analyzed is pulled from the storage media of the past events history rather than received over the network. A probability density function is generated by the machine learning model which has a probability value for each number events. Training is done by performing loss function computation and loss function optimization on the training dataset.
As illustrated in FIG. 5C, the training dataset is assembled by selecting a number of consecutive security events, augmenting the events with the delay/lag information; using the last value of the lag as an example of an observed value and the events with lags preceding it as the input value for the machine learning model that is undergoing the training process. In FIG. 5D, the machine learning model is configured to output a probability density function (PbDF) that best reflects the expected behavior of actors and access patterns at doors and sites. Training machine learning models which compute PbDF function for security events augmented with lag/delay information is done by performing the loss function computation and loss function optimization on the training dataset. When the loss function has been minimized, the “trained” model is stored into a repository for future selection.

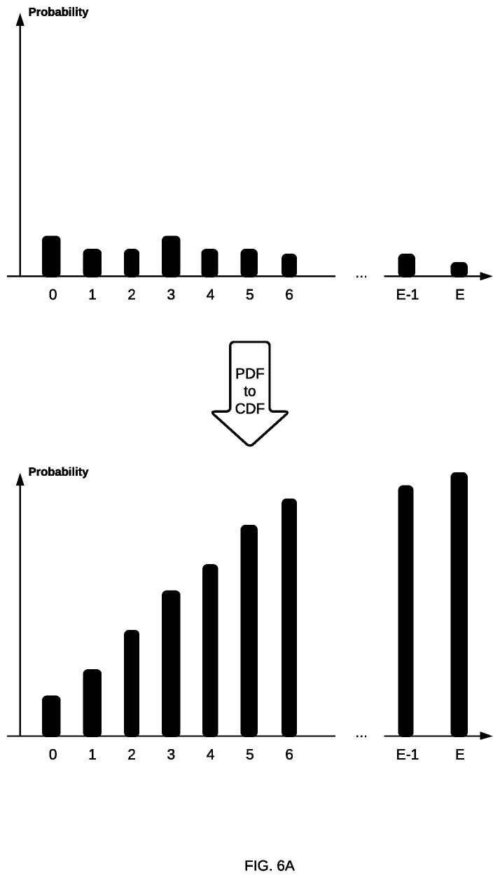

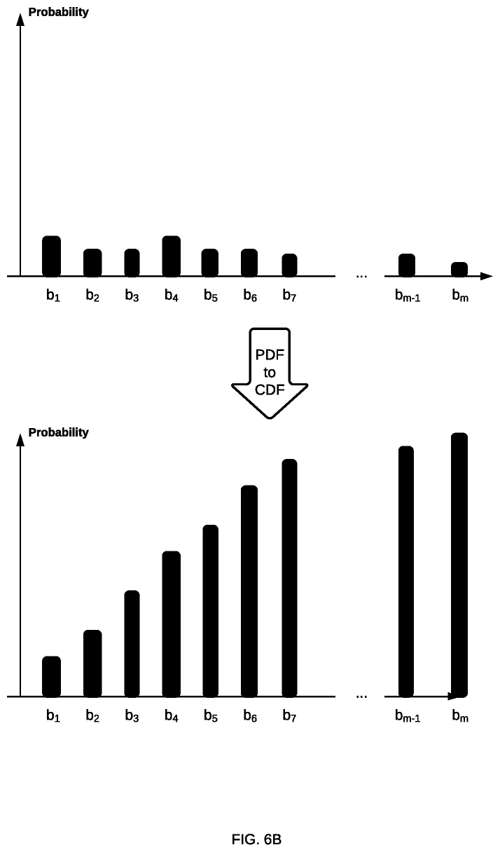

Referring now to FIG. 6A and FIG. 6B, a conceptual illustration is provided to assist in appreciation of the invention without limiting the actual claims or bounds. In FIG. 6A a Probability Density Function is illustrated as a graph for a count of an event occurring within a time interval. The horizontal axis represents the possible event count that may be observed during the time interval in consideration. The vertical axis represents the likelihood or probability of the event count to be observed. Here the most likely non-zero number of events in this particular time interval is 3. The sum of the values of the probability density function over its domain is always 1. By performing the cumulative sum procedure the cumulative distribution function is obtained. The horizontal axis represents the upper bound for the number of events that may be observed, the vertical axis represents the likelihood or probability of observing the indicated number of events or fewer.

Referring now to FIG. 6B. a conceptual illustration is provided to assist in appreciation of the invention with regard to a Probability Density Function shown as a graph for the lag or delay observed for the current security event. The horizontal axis represents possible intervals that the observed delay may fall into, thus dividing the continuum of possible delay values into a finite number of bins, The vertical axis represents the likelihood or probability of observing the indicated delays conditional on the observed delays for the history of the past security events. Bin b1 or bin b4 seem tied in representing the most common inter-event arrival gaps for this selected history. The cumulative density function is obtained by performing the cumulative sum procedure. The horizontal axis represents the possibility of observing a delay that is less than or equal to the indicated value, the vertical axis represents the probability of observing a delay that is less than or equal to the indicated value on the horizontal axis.
In an embodiment, probability density functions and cumulative density function are stored as one dimensional arrays of numbers. The length of an array is not fixed and can vary depending on the values observed in the history of the security events during training of the machine learning models. Other embodiments may store these functions as arrays of array or matrices or in the case of sparse matrices, in various compression schema.
We use PbDF and PDF interchangeably for abbreviation of Probability Density Function.

### Exemplary Non-Limiting Embodiments

One aspect of the invention is a method for computing an anomaly score for a physical access event including the steps: receiving a physical access security event (security event) packet for analysis at a server; extracting identifying indicia (identifiers) for the security event; choosing a subset of the identifiers for a first analysis; retrieving from non-transitory storage a plurality of stored security events (history) of length N for the chosen subset of identifiers of said first analysis; transforming the retrieved history of security events into a data structure for a time series of event counts for a first machine learning model; storing said data structure for time series of event counts; selecting a predictive model; applying the selected predictive model to the transformed retrieved stored event indicia; determining a first probability density function (PbDF); determining a cumulative distribution function (CDF) from the PbDF; and determining an anomaly score result for the current event indicia by evaluating the CDF.

In an embodiment identifying indicia include actor, door and site, date and time, and event type. In an embodiment transforming the retrieved history of security events into a data structure for a time series of event counts includes windowing over regular time intervals. In an embodiment determining a first probability density function (PbDF) is: selecting from a plurality of machine learning models a predictive model that is trained for computing probability density functions for the subset of security event identifiers chosen for said first analysis; and computing the probability density function (PbDF) by the selected predictive model using the data structure for times series of event counts.

In an embodiment, computing the PbDF includes: reading from storage a machine learning model configuration that matches the selected subset of identifiers; using publicly available machine learning computer executable code libraries to load the model into a processor core; and invoking machine learning model code to compute probability density function from the input data structure. In an embodiment, determining a cumulative distribution function CDF from the Probability Density Function is by cumulative summing. In an embodiment, determining an anomaly score result for the current event indicia by evaluating the CDF is applying the value of event count for any time interval.

One aspect of the invention is a method at a server having the processes:

receiving an event stream containing a physical access security event (current event) packet for analysis at a server; extracting identifying indicia (identifiers) for the current event from said packet; selecting a subset of the identifying indicia of the current event for a first analysis; retrieving from non-transitory storage a plurality of stored physical access security events (events) of length N+1 for the identifiers of said first analysis; augmenting the N+1 events with the lag information by computing the time difference in units of time between each pair of a physical access security event and its subsequent physical access security event and discarding the event N+1 from the data structure; storing said augmented events in a data structure format for a time series of event counts into non-transitory media; determining a second probability density function (PbDF) by applying the selected predictive model to the augmented retrieved stored event history; determining a cumulative distribution function (CDF) from the second Probability Density Function by summing in an accumulator; and determining an anomaly score result for the current event by evaluating the CDF for the identifying indicia of the current event.

In an embodiment, identifying indicia include actor, door and site, date and time, and event type. In an embodiment, the history of security events is augmented with time delay/lag information. In an embodiment, the method includes: selecting from the plurality of machine learning models a predictive model that is trained for computing the probability density functions for the selected combination of security event identifiers chosen for said second analysis. In an embodiment, computing the probability density function (PbDF) by the selected predictive model includes: reading from a store a machine learning model configuration that matches the selected indicia; using publicly available machine learning computer executable code libraries to load the model into a processor core; and invoking machine learning model code to compute probability density function (PbDF) from the input data structure. In an embodiment, the method includes: transforming the Probability Distribution Function into a Cumulative Probability Distribution Function by performing a cumulative summing process. In an embodiment, the method includes: determining the event count for one of a current time interval and a future time interval; applying said event count to the Cumulative Probability Distribution Function; assigning the resulting output as an anomaly score; and, inserting an anomaly packet into the event stream.

One aspect of the invention is a method for creation of a plurality of machine learning models for determining a Probability Distribution Function (PbDF) function for data formatted as a time series of event counts, the method including processes following: retrieving from non-transitory storage a plurality of stored security event datasets of length N for the identifiers of said security events; transforming each retrieved stored event datasets into a first data structure for a time series of event counts for a machine learning model; transforming said first data structure into a first machine learning model; initializing said first machine learning model with randomly generated configuration and parameters; adjusting configuration and parameters of said first machine learning model via a loss function optimization procedure; and storing the adjusted machine learning model to a non-transitory repository of machine learning models. In an embodiment, the loss function is a categorical cross-entropy loss. In an embodiment, the optimization procedure is the stochastic gradient descent algorithm.

One aspect of the invention is a method for creation of machine learning models for Probability Distribution Function (PbDF) computations for security event time series augmented with lag/delay information, the method including the processes: retrieving from non-transitory storage a plurality of stored security event datasets of length N+2 for the identifying indicia (identifiers) of said event; augmenting each event dataset with the lag/delay information by computing the time difference in units of time between each first security event and its subsequent security event and discarding the event N+2 from the data structure; creating and initializing a machine learning model with randomly generated configuration and parameters; adjusting configuration and parameters of the machine learning model via a loss function optimization procedure; and storing said adjusted machine learning model to a repository of machine learning models. In an embodiment, the loss function is a categorical cross-entropy loss. In an embodiment, the optimization procedure is the stochastic gradient descent algorithm.

One aspect of the invention is a non-transitory computer readable storage medium impressed with computer program instructions to execute a method for anomaly detection. One aspect of the invention is a non-transitory computer readable storage medium impressed with computer-executable program instructions to perform the process steps of anomaly detection described above. One aspect of the invention is a non-transitory computer readable storage medium impressed with computer-executable program instructions to perform the method of anomaly detection described above. One aspect of the invention is a non-transitory computer readable storage medium impressed with computer-executable program instructions to execute the method of anomaly detection described above.

One aspect of the invention is a system having: at least one processor coupled to an instruction and data store (memory); a non-transitory computer readable storage medium; an accumulator; and a network interface, the memory loaded with computer instructions stored in said non-transitory computer readable storage medium, whereby the network interface is utilized to receive security events for analysis, retrieving history of security events from a database and retrieving machine learning models from the model repository.

One aspect of the invention is a system having at least one processor coupled to a non-transitory media instruction store (memory) and a network interface, the memory loaded with computer instructions stored in the non-transitory computer readable storage medium, whereby the processor causes the network interface to receive security events for analysis, to retrieve history of security events from a database, and to retrieve machine learning models from a model repository.

One aspect of the invention is a system having: at least one processor; coupled to a computer-readable memory apparatus (memory); a network interface; and a non-transitory computer readable storage medium, whereby said processor is caused to receive security events for analysis, to retrieve history of security events from a database, and to retrieve machine learning models from a model repository through the network interface.

One aspect of the invention is a system having: at least one processor; coupled to all of the following, a memory apparatus (memory); a non-transitory media encoded with executable instructions (computer instructions); a model repository store; and a network interface, the memory loaded with said computer instructions causing said network interface to receive security events for analysis, to retrieve history of security events from a database, and to retrieve machine learning models from said model repository.

Embodiments of the present invention can be implemented in connection with a variety of Information Technology (IT) infrastructures, including for example, physical access control systems, video security surveillance, self-driving vehicles, autonomous trading methods, sensor data output by an Internet of Things (IoT), application performance monitoring, transportation/shipping management, etc.

### CONCLUSION

The invention can be easily distinguished from conventional systems by receiving a stream of security events from physical access control devices, at portals. The invention can be easily distinguished by having a plurality of small machine learning models which are selected according to the indicia of an incoming security event. The invention can be easily distinguished by selecting a subset of the characteristics of an anomaly for simpler machine learning and probability calculations. The invention can be easily distinguished by forming and inserting an anomaly alert packet into the event stream on the detection of an event of very low probability e.g. exceeding a multiple of standard deviation. The plurality of training machines improves performance and distribution across a server array.

Conventional system include large model building systems and generally one or a few centralized models. None of the well-known references separately or together suggest focus on the attributes of a physical access control anomaly detection. None of the well-known references separately or together suggest focus on a subset of the indicia of each event's data set for anomaly detection. None of the well-known references separately or together suggest selecting from among a plurality of small machine learning models trained for an actor, or a door, or a site, or a date and time.

The methodologies of embodiments of the disclosure may be particularly well-suited for use in an electronic device or alternative system. Accordingly, embodiments of the present invention may take the form of an entirely hardware embodiment or an embodiment combining software and hardware aspects that may all generally be referred to herein as a “processor,” “circuit,” “module” or “system.”

Furthermore, it should be noted that any of the methods described herein can include an additional step of providing a computer system implementing a method for anomaly alarm consolidation. Further, a computer program product can include a tangible computer-readable recordable storage medium with code adapted to be machine-executed to carry out one or more method steps described herein, including the provision of the system with the distinct software modules. One or more embodiments of the invention, or elements thereof, can be implemented in the form of an apparatus including a memory and at least one processor that is coupled to the memory and operative to perform exemplary method steps.

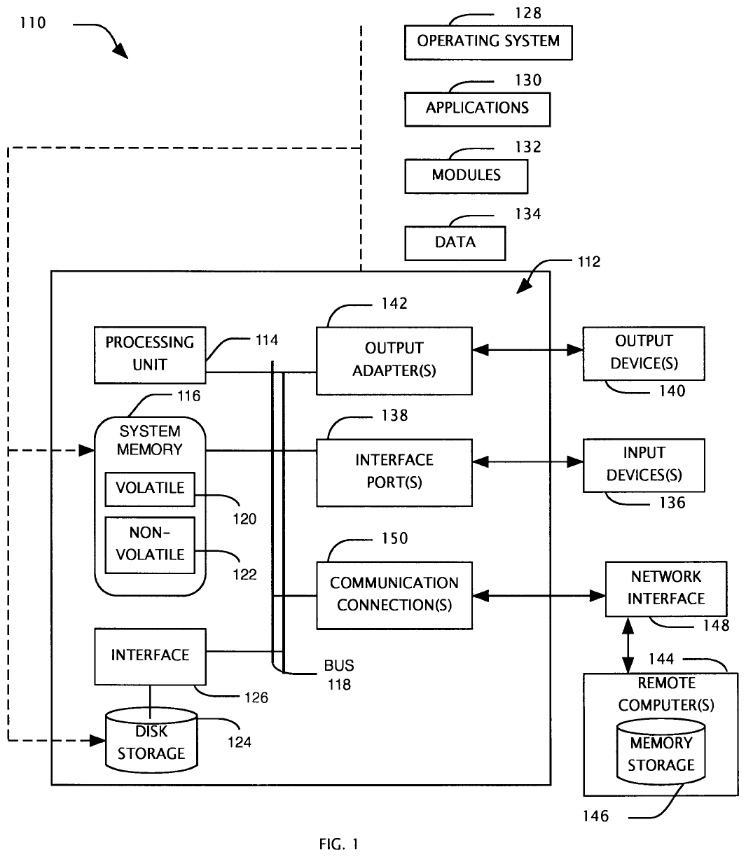

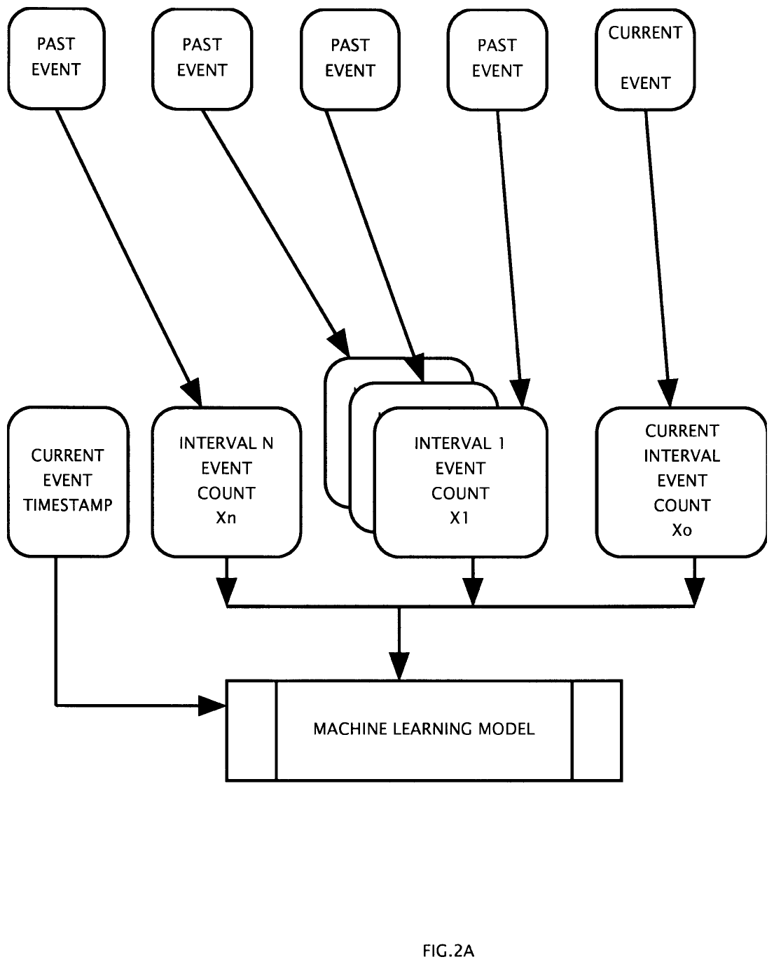

FIG. 1 depicts a computer system that may be useful in implementing one or more aspects and/or elements of the invention, also representative of a cloud computing node according to an embodiment of the present invention. Referring now to FIG. 1, cloud computing node 110 is only one example of a suitable cloud computing node and is not intended to suggest any limitation as to the scope of use or functionality of embodiments of the invention described herein. Regardless, cloud computing node 110 is capable of being implemented and/or performing any of the functionality set forth hereinabove.

In cloud computing node 110 there is a computer system/server 112, which is operational with numerous other general purpose or special purpose computing system environments or configurations. Examples of well-known computing systems, environments, and/or configurations that may be suitable for use with computer system/server 112 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like exemplary represented as at least one remote computer 144 having memory storage 146 for at least one of data and instructions.

Computer system/server 112 may be described in the general context of computer system executable instructions, such as applications 130 program modules 132, being platformed by a computer operating system 128 and engaged in at least one of receiving, transforming, and transmitting data 134. Generally, program modules 132 may include routines, programs, objects, components, logic, data structures, and so on that perform particular tasks or implement particular abstract data types. Computer system/server 112 may be practiced in distributed cloud computing environments where tasks are performed by remote processing devices that are linked through a communications network. In a distributed cloud computing environment, program modules may be located in both local and remote computer system storage media including memory storage devices 146.

As shown in FIG. 1, computer system/server 112 in cloud computing node 110 is shown in the form of a general-purpose computing device. The components of computer system/server 112 may include, but are not limited to, one or more processors or processing units (processors, cores) 114, a system memory 116, and a bus 118 that couples various system components including system memory 116 to processor 114. Processors, cores, and units may also communication with one another through shared memory service and inter-process communication (IPC) in some embodiments.

Bus 118 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 112 typically includes a variety of computer system readable media. Such media may be any available media that is accessible by computer system/server 112, and it includes both volatile and non-volatile media, removable and non-removable media.

System memory 116 can include computer system readable media in the form of volatile memory, such as random access memory (RAM) 120 and/or cache memory as well as non-volatile devices 122 for configuration and initialization (microcode). Computer system/server 112 may further include other removable/non-removable, volatile/non-volatile computer system storage media. By way of example only, storage system can be provided for reading from and writing to a non-removable, non-volatile magnetic or optical media (typically called a “hard drive” or disk storage 124). Such a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 118 by one or more data media interfaces 126. As will be further depicted and described below, memory 116 may include at least one program product having a set (e.g., at least one) of program modules that are configured to carry out the functions of embodiments of the invention.

Application/program/utility 130, having a set (at least one) of program modules 132, may be stored in memory 116 by way of example, and not limitation, as well as an operating system, one or more application programs, other program modules, and program data. Each of the operating system, one or more application programs, other program modules, and program data or some combination thereof, may include an implementation of a networking environment. Program modules 132 generally carry out the functions and/or methodologies of embodiments of the invention as described herein.

Computer system/server 112 may also communicate with one or more external devices. In an embodiment, coupled to the bus 118 are Output Adapters 142, Interface Ports 138, and Communication Connections 150. Input devices 136 such as a keyboard, a pointing device, a touch display, etc. may be coupled to the system via said interface port(s) 138. One or more devices that enable a user to interact with computer system/server 112 or receive the results of performing a method on output devices 140 such as printers, speaker, video displays, projectors, actuators through an output adapter 142. Other systems and networks may be coupled through a communications connection 150 and/or any devices (e.g., network card, modem, etc.) that enable computer system/server 112 to communicate with one or more other computing devices. Such communication can occur via Input/Output (I/O) interfaces 138 142. Still yet, computer system/server 112 can communicate with one or more networks such as a local area network (LAN), a general wide area network (WAN), and/or a public network (e.g., the Internet) via network interface 148. As depicted, network interface communicates with remote computer system/server 144 and may access memory storage 146 at remote computers 144. It should be understood that although not shown, other hardware and/or software components could be used in conjunction with computer system/server 112. Examples, include, but are not limited to: microcode, device drivers, redundant processing units, and external disk drive arrays, RAID systems, tape drives, and data archival storage systems, etc.

Thus, one or more embodiments can make use of software running on a general purpose computer or workstation. With reference to FIG. 1, such an implementation might employ, for example, a processor 114, a memory 116, and an input/output interface to output devices 140 (a display and external device(s) such as a keyboard, a pointing device, or the like). The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 120, ROM (read only memory) aka non-volatile 122, a fixed memory device (for example, hard drive 124), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processors, memory, and input/output interface can be interconnected, for example, via bus 118 as part of a data processing unit 112. Suitable communication connections 150, for example via bus 118, can also be provided to a network interface 148, such as a network card, which can be provided to interface with a computer network, and to a media interface, such as a diskette or CD-ROM drive, which can be provided to interface with suitable media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 114 coupled directly to system memory elements 116 or indirectly through a system bus 118. The memory elements can include volatile memory 120 employed during actual implementation of the program code, bulk storage, and cache memories which provide temporary storage of at least some program code in order to reduce the number of times code must be retrieved from bulk storage during implementation, and non-volatile memory 122 employed to configure and initialize the processing unit during “bootup”.

Input/output or I/O devices (including but not limited to keyboards, displays, pointing devices, and the like) can be coupled to the system either directly or through intervening I/O controllers.

Network interface(s) 148 may also be coupled to the system to enable the data processing system to become coupled to other data processing systems or remote printers or storage devices through intervening private or public networks. Modems, cable modem and Ethernet cards are just a few of the currently available types of network interfaces.

As used herein, including the claims, a “server” includes a physical data processing system running a server program. It will be understood that such a physical server may or may not include a display and keyboard.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors or processor cores. Further, a computer program product can include a non-transitory computer-readable storage medium with encoded machine executable instructions adapted to be implemented to carry out one or more method steps described herein, including the provision of the system with the distinct software modules.

One example of a user interface that could be employed in some cases is hypertext markup language (HTML) code served out by a server or the like, to a browser of a computing device of a user. The HTML is parsed by the browser on the user's computing device to create a graphical user interface (GUI). Another example of a well-known user interface is HTTP including but not limited to GET, POST, PUT, PATCH, and DELETE, the five most common HTTP methods for retrieving from and sending data to a server.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for computing an anomaly score for a physical access event comprising:
receiving a physical access security event (security event) packet for analysis at a server;
extracting identifying indicia (identifiers) for the security event;
choosing a subset of the identifiers for a first analysis;
retrieving from non-transitory storage a plurality of stored security events (history) of length N for the chosen subset of identifiers of said first analysis;
transforming the retrieved history of security events into a data structure for a time series of event counts for a first machine learning model;
storing said data structure for time series of event counts;
selecting a predictive model;
applying the selected predictive model to the transformed retrieved stored event indicia;
determining a first probability density function (PbDF);
determining a cumulative distribution function (CDF) from the PbDF; and
determining an anomaly score result for the current event indicia by evaluating the CDF.

2. The method of claim 1 wherein identifying indicia include actor, door and site, date and time, and event type.

3. The method of claim 1 wherein transforming the retrieved history of security events into a data structure for a time series of event counts comprises windowing over regular time intervals.

4. The method of claim 1 wherein determining a first probability density function (PbDF) comprises:
selecting from a plurality of machine learning models a predictive model that is trained for computing probability density functions for the subset of security event identifiers chosen for said first analysis; and
computing the probability density function (PbDF) by the selected predictive model using the data structure for times series of event counts.

5. The method of claim 4 wherein computing the PbDF comprises:
reading from storage a machine learning model configuration that matches the selected subset of identifiers;
using publicly available machine learning computer executable code libraries to load the model into a processor core; and
invoking machine learning model code to compute probability density function from the input data structure.

6. The method of claim 1 wherein determining a cumulative distribution function CDF from the Probability Density Function is by cumulative summing.

7. The method of claim 1 wherein determining an anomaly score result for the current event indicia by evaluating the CDF is applying the value of event count for any time interval.

8. A method at a server comprising the processes:
receiving an event stream containing a physical access security event (current event) packet for analysis at a server;
extracting identifying indicia (identifiers) for the current event from said packet;
selecting a subset of the identifying indicia of the current event for a first analysis;
retrieving from non-transitory storage a plurality of stored physical access security events (events) of length N+1 for the identifiers of said first analysis;
augmenting the N+1 events with the lag information by computing the time difference in units of time between each pair of a physical access security event and its subsequent physical access security event and discarding the event N+1 from the data structure;
storing said augmented events in a data structure format for a time series of event counts into non-transitory media;
determining a second probability density function (PbDF) by applying the selected predictive model to the augmented retrieved stored event history;
determining a cumulative distribution function (CDF) from the second Probability Density Function by summing in an accumulator; and
determining an anomaly score result for the current event by evaluating the CDF for the identifying indicia of the current event.

9. The method of claim 8 wherein identifying indicia include actor, door and site, date and time, and event type.

10. The method of claim 9 wherein the history of security events is augmented with time delay/lag information.

11. The method of claim 10 further comprising:
selecting from the plurality of machine learning models a predictive model that is trained for computing the probability density functions for the selected combination of security event identifiers chosen for said second analysis.

12. The method of claim 11 wherein computing the probability density function (PbDF) by the selected predictive model comprises:
reading from a store a machine learning model configuration that matches the selected indicia;
using publicly available machine learning computer executable code libraries to load the model into a processor core; and
invoking machine learning model code to compute probability density function (PbDF) from the input data structure.

13. The method of claim 12 further comprising:
transforming the Probability Distribution Function into a Cumulative Probability Distribution Function by performing a cumulative summing process.

14. The method of claim 13 further comprising:
determining the event count for one of a current time interval and a future time interval;
applying said event count to the Cumulative Probability Distribution Function;
assigning the resulting output as an anomaly score; and,
inserting an anomaly packet into the event stream.

15. A method for creation of a plurality of machine learning models for determining a Probability Distribution Function (PbDF) function for data formatted as a time series of event counts, the method comprising:
retrieving from non-transitory storage a plurality of stored security event datasets of length N for the identifiers of said security events;
transforming each retrieved stored event datasets into a first data structure for a time series of event counts for a machine learning model;
transforming said first data structure into a first machine learning model;
initializing said first machine learning model with randomly generated configuration and parameters;
adjusting configuration and parameters of said first machine learning model via a loss function optimization procedure; and
storing the adjusted machine learning model to a non-transitory repository of machine learning models.

16. The method of claim 15, wherein the loss function is a categorical cross-entropy loss.

17. The method of claim 15, wherein the optimization procedure is the stochastic gradient descent algorithm.

18. A method for creation of machine learning models for Probability Distribution Function (PbDF) computations for security event time series augmented with lag/delay information, the method comprising;
retrieving from non-transitory storage a plurality of stored security event datasets of length N+2 for the identifying indicia (identifiers) of said event;
augmenting each event dataset with the lag/delay information by computing the time difference in units of time between each first security event and its subsequent security event and discarding the event N+2 from the data structure;
creating and initializing a machine learning model with randomly generated configuration and parameters;
adjusting configuration and parameters of the machine learning model via a loss function optimization procedure; and
storing said adjusted machine learning model to a repository of machine learning models.

19. The method of claim 18, wherein the loss function is a categorical cross-entropy loss.

20. The method of claim 18, wherein the optimization procedure is the stochastic gradient descent algorithm.

21. A non-transitory computer readable storage medium impressed with computer program instructions to execute the method of claim 1.

22. A non-transitory computer readable storage medium impressed with computer-executable program instructions to perform the process steps of claim 8.

23. A non-transitory computer readable storage medium impressed with computer-executable program instructions to perform the method of claim 15.

24. A non-transitory computer readable storage medium impressed with computer-executable program instructions to execute the method of claim 18.

25. A system comprising:
at least one processor coupled to an instruction and data store (memory);
a non-transitory computer readable storage medium of claim 21;
an accumulator; and
a network interface,
the memory loaded with computer instructions stored in said non-transitory computer readable storage medium, whereby the network interface is utilized to receive security events for analysis, retrieving history of security events from a database and retrieving machine learning models from the model repository.

26. A system comprising at least one processor coupled to a non-transitory media instruction store (memory) and a network interface, the memory loaded with computer instructions stored in the non-transitory computer readable storage medium of claim 22, whereby the processor causes the network interface to receive security events for analysis, to retrieve history of security events from a database, and to retrieve machine learning models from a model repository.

27. A system comprising:
at least one processor; coupled to
a computer-readable memory apparatus (memory);
a network interface; and
the non-transitory computer readable storage medium of claim 23,
whereby said processor is caused to receive security events for analysis, to retrieve history of security events from a database, and to retrieve machine learning models from a model repository through the network interface.

28. A system comprising:
at least one processor; coupled to all of the following,
a memory apparatus (memory);
a non-transitory media encoded with executable instructions (computer instructions) of claim 24;
a model repository store; and
a network interface, the memory loaded with said computer instructions causing said network interface to receive security events for analysis, to retrieve history of security events from a database, and to retrieve machine learning models from said model repository.
